(19) United States
(12) Patent Application Publication
(10) Pub. No.: US 2024/0331037 A1
(43) Pub. Date: Oct. 3, 2024

(54) MANAGEMENT OF CUSTODIAN-HELD SECURITIES BASED ON CONVERSION SCORES

(71) Applicant: LPL FINANCIAL, LLC, Boston, MA (US)

(72) Inventors: Manish Pillai, Charlotte, NC (US); Nilay Pal, Huntersville, NC (US); Raymond Wong, Union City, CA (US)

(21) Appl. No.: 18/127,259

(22) Filed: Mar. 28, 2023

(51) Int. Cl. G06Q 40/04; G06Q 40/03

(52) U.S. Cl. CPC G06Q 40/04; G06Q 40/03; G06Q 2220/00

(57) ABSTRACT

A method, a system, and computer program product for managing upgrades of cloud-based software applications are provided. A request to convert assets is received. Historical data and current data associated with the assets is retrieved. A conversion score is generated for converting the one or more assets. The conversion score includes a weighted sum of a plurality of risk scores, each of the plurality of risk scores being determined by using a machine learning model including a convolution function configured to process the historical data and the current data. A conversion of the assets is selectively enabled based on a comparison of the conversion score to a threshold. Current data associated with the assets is updated and display based on the conversion.

### TECHNICAL FIELD

The present disclosure generally relates to data processing and, more specifically, to conversion of custodian-held securities-based assets by using cryptographically-secured digital currencies and tokens.

### BACKGROUND

Many organizations can rely on traditional finance methods to provide financial liquidity to customers. The traditional finance methods can include transactions of personal loans, home equity loans, credit cards, or even loaning against retirement plans, and/or the like. In some cases, brokerage accounts can be liquidated to obtain access to liquid cash, because of high barrier to obtain liquidity against security based assets. Most brokerage entities do not offer any program to access tangible assets against an investment portfolio that includes equities, mutual funds, exchange-traded funds, and/or the like. In some cases, where brokerage entities offer a program to access tangible assets against an investment portfolio, the program can require the borrower to navigate a lengthy and cumbersome process, which could raise unpredictable issues, including data security risks.

### SUMMARY

Methods, systems, and articles of manufacture, including computer program products, are provided for managing custodian-held securities based on conversion scores. In one aspect, a system includes: one or more computer processors, a database storing a plurality of documents, the plurality of documents including asset related documents, a data analysis system, executable upon the one or more computer processors, to perform operations including: receiving a request to convert one or more assets that are linked to a user, retrieving, from a database and by using a user identifier, historical data and current data associated with the one or more assets, the historical data including analytical parameters associated with the one or more assets and the current data including current conversion factors applicable to the one or more assets, generating a conversion score for converting the one or more assets, the conversion score including a weighted sum of a plurality of risk scores, each of the plurality of risk scores being determined by using a machine learning model including a convolution function configured to process the historical data and the current data, selectively enabling a conversion of the one or more assets based on a comparison of the conversion score to a conversion threshold, using the conversion to automatically generate an update of the current data associated with the one or more assets, and providing an instruction to display information indicating the conversion and the update of the current data associated with the one or more assets.

In some variations, one or more features disclosed herein including the following features can optionally be included in any feasible combination. In some implementations, the operations further include: performing a user authentication, determining whether the request originates from a whitelisted server, and retrieving, from a risk score system, via a secure gateway, the historical data associated with the user. In some implementations, the historical data is encrypted for transmission, via the secure gateway. In some implementations, the operations further include: generating a notification indicating completion of asset conversion. In some implementations, one of the one or more assets includes a blockchain asset. In some implementations, selectively enabling the conversion of the one or more assets includes blocking the conversion of the one or more assets based on determining that the conversion score is smaller than the conversion threshold or automatically executing the conversion of the one or more assets based on determining that the conversion score is greater than the conversion threshold. In some implementations, the conversion of the one or more assets includes generating a converted asset value. In some implementations, the machine learning model includes a recurrent neural network. In some implementations, the operations further include: executing, using a smart contract, a transaction of the one or more assets using the converted asset value. In some implementations, the analytical parameters include data recorded over a past period of time, encrypted, and stored in a distributed database of a system. In some implementations, the current conversion factors include external values associated with the asset.

In another aspect, a non-transitory computer-readable storage medium includes programming code, which when executed by at least one data processor, causes operations including: receiving a request to convert one or more assets that are linked to a user, retrieving, from a database and by using a user identifier, historical data and current data associated with the one or more assets, the historical data including analytical parameters associated with the one or more assets and the current data including current conversion factors applicable to the one or more assets, generating a conversion score for converting the one or more assets, the conversion score including a weighted sum of a plurality of risk scores, each of the plurality of risk scores being determined by using a machine learning model including a convolution function configured to process the historical data and the current data, selectively enabling a conversion of the one or more assets based on a comparison of the conversion score to a conversion threshold, using the conversion to automatically generate an update of the current data associated with the one or more assets, and providing an instruction to display information indicating the conversion and the update of the current data associated with the one or more assets.

In some variations, one or more features disclosed herein including the following features can optionally be included in any feasible combination. In some implementations, the operations further include: performing a user authentication, determining whether the request originates from a whitelisted server, and retrieving, from a risk score system, via a secure gateway, the historical data associated with the user. In some implementations, the historical data is encrypted for transmission, via the secure gateway. In some implementations, the operations further include: generating a notification indicating completion of asset conversion. In some implementations, one of the one or more assets includes a blockchain asset. In some implementations, selectively enabling the conversion of the one or more assets includes blocking the conversion of the one or more assets based on determining that the conversion score is smaller than the conversion threshold or automatically executing the conversion of the one or more assets based on determining that the conversion score is greater than the conversion threshold. In some implementations, the conversion of the one or more assets includes generating a converted asset value. In some implementations, the machine learning model includes a recurrent neural network. In some implementations, the operations further include: executing, using a smart contract, a transaction of the one or more assets using the converted asset value. In some implementations, the analytical parameters include data recorded over a past period of time, encrypted, and stored in a distributed database of a system. In some implementations, the current conversion factors include external values associated with the asset.

In another aspect, a computer-implemented method includes: at least one data processor; and at least one memory storing instructions, which when executed by the at least one data processor, cause operations including: receiving, by one or more processors, a request to convert one or more assets that are linked to a user, retrieving, by the one or more processors, from a database and by using a user identifier, historical data and current data associated with the one or more assets, the historical data including analytical parameters associated with the one or more assets and the current data including current conversion factors applicable to the one or more assets, generating, by the one or more processors, a conversion score for converting the one or more assets, the conversion score including a weighted sum of a plurality of risk scores, each of the plurality of risk scores being determined by using a machine learning model including a convolution function configured to process the historical data and the current data, selectively enabling, by the one or more processors, a conversion of the one or more assets based on a comparison of the conversion score to a conversion threshold, using, by the one or more processors, the conversion to automatically generate an update of the current data associated with the one or more assets, and providing, by the one or more processors, an instruction to display information indicating the conversion and the update of the current data associated with the one or more assets.

In some variations, one or more features disclosed herein including the following features can optionally be included in any feasible combination. In some implementations, the computer-implemented method further includes: performing a user authentication, determining whether the request originates from a whitelisted server, and retrieving, from a risk score system, via a secure gateway, the historical data associated with the user. In some implementations, the historical data is encrypted for transmission, via the secure gateway. In some implementations, the computer-implemented method further includes: generating a notification indicating completion of asset conversion. In some implementations, one of the one or more assets includes a blockchain asset. In some implementations, selectively enabling the conversion of the one or more assets includes blocking the conversion of the one or more assets based on determining that the conversion score is smaller than the conversion threshold or automatically executing the conversion of the one or more assets based on determining that the conversion score is greater than the conversion threshold. In some implementations, the conversion of the one or more assets includes generating a converted asset value. In some implementations, the machine learning model includes a recurrent neural network. In some implementations, the computer-implemented method further includes: executing, using a smart contract, a transaction of the one or more assets using the converted asset value. In some implementations, the analytical parameters include data recorded over a past period of time, encrypted, and stored in a distributed database of a system. In some implementations, the current conversion factors include external values associated with the asset.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that can include one or more processors and one or more memories coupled to the one or more processors. A memory, which can include a non-transitory computer-readable or machine-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to customization of database tables, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a diagram illustrating an example of a system, in accordance with some example implementations;

FIGS. 2A-2D depict examples of scoring models, in accordance with some example implementations;

FIG. 3 depicts a process for customizing database tables, in accordance with some example implementations; and

FIG. 4 depicts a diagram illustrating a computing system, in accordance with some example implementations.

When practical, like labels are used to refer to same or similar items in the drawings.

### DETAILED DESCRIPTION

Implementations of the present disclosure are generally directed to software application based conversions of assets. More particularly, implementations of the present disclosure are directed to managing custodian-held securities by using a conversion score. The conversion score can be generated by using a machine learning (ML) model configured to process the historical data and current data associated with a user requesting an asset based transaction. The conversion score can be used to manage custodian-held securities to securely access tangible assets to enable secure transactions using the tangible assets. For example, an asset conversion can be selectively enabled based on a comparison of the conversion score to a conversion threshold. The conversion can be used to automatically generate an update of the current data associated with the assets. The conversion and the update of the current data can be displayed to the user requesting the asset based transaction.

Traditional access to tangible assets derived from custodian-held securities was often limited to a small portion of the users. For example, processes to provide access to tangible assets without disturbing long term assets could include lengthy processes that could raise security issues, being vulnerable to fraud and/or asset and private data attacks. The duration of such conversion processes and the associated risks for accessing the tangible assets limited the applicability of traditional asset conversion processes. In some cases, the duration of such conversion processes can lead to transaction incompatibilities due to external variable factors that could add inaccuracy in asset value conversion, preventing completion of transactions.

To avoid the drawbacks of traditional asset conversion processes described above, conversion scores are used to accurately determine a target asset type value (e.g., cryptographic currency value) of traditional non-tangible assets (e.g., custodian-held securities). The conversion scores can be adjusted relative to multiple variable external factors, such as various external macroeconomic as well as local market factors. Using the implementations described herein, the conversion scores are generated based on a predictive assessment of current asset data relative to historical asset data and based on current parameters received from multiple environments affected by the conversion and the target transaction. For example, the conversion scores are generated based on public data, real-time market data, traditional interest rates data that are processed by ML to arrive at a dynamic scoring value for the traditional non-tangible assets. The conversion for asset transaction system includes a blockchain network to generate cryptographically-valid tokens against traditional non-tangible assets, which provides transparency, data security, asset security, and immutability. The derived conversion scores are made visible to the user and, in some cases, to one or more parties affected by the conversion and/or the transaction. The visibility of the conversion scores, enables elimination of conversion uncertainties, minimizing incidents and optimizing computational resources involved in asset management.

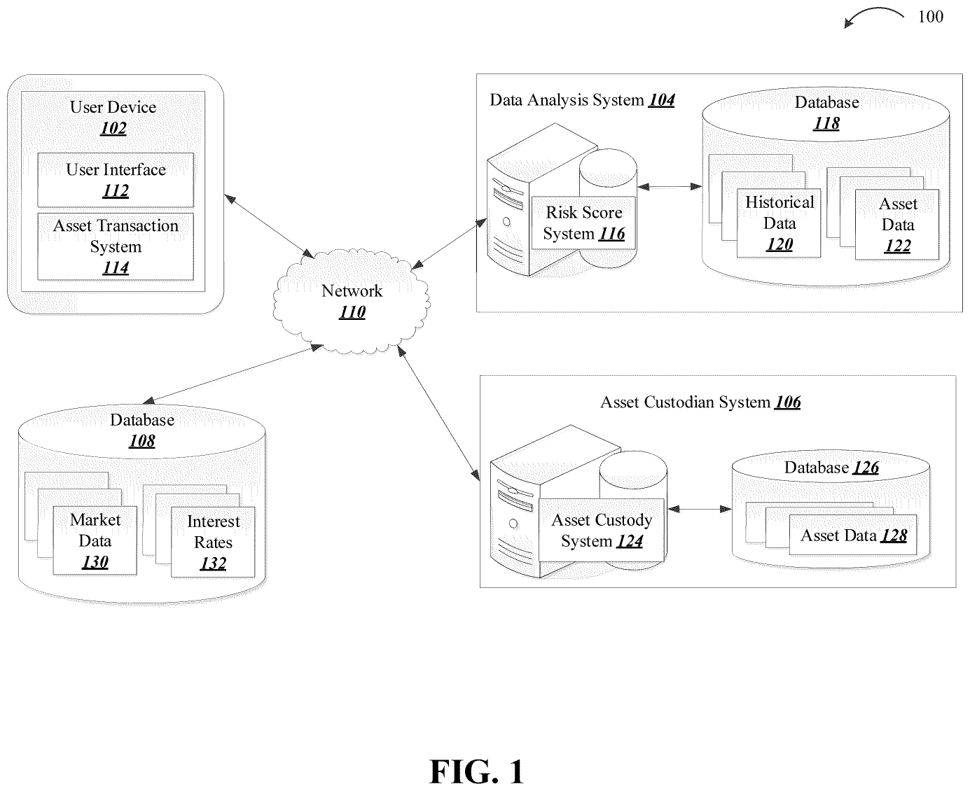

FIG. 1 depicts an example of a system 100, in accordance with some example implementations. Referring to FIG. 1, the example system 100 includes a user device 102, a data analysis system 104, an asset custodian system 106, an external database 108, and a network 110.

The user device 102 can include one or more devices communicatively coupled with the data analysis system 104 to access asset transaction applications using non-tangible assets handled, by the asset custodian system 106. The user device 102 can be and/or include any type of processor and memory based device, such as, for example, cellular phones, smart phones, tablet computers, laptop computers, desktop computers, workstations, personal digital assistants (PDA), network appliances, cameras, enhanced general packet radio service (EGPRS) mobile phones, media players, navigation devices, email devices, game consoles, or an appropriate combination of any two or more of these devices or other data processing devices. Even though, not illustrated, in some implementations, multiple user devices 102 including different computing system configurations, such as different operating systems, different processing capabilities, different hardware components, and/or other differences can concurrently request asset transaction services, from the data analysis system 104. The user device 102 can include any combination of fixed and variable computing components. The user device 102 can include a user interface 112 and an asset transaction system 114. The user interface 112 can include an input interface and an output interface. The input interface includes a component that permits the user device 102 to receive information, such as via user input (e.g., a touchscreen display, a keyboard, a keypad, a mouse, a button, a switch, a microphone, a camera, and/or the like). The output interface includes a component that provides output information from the user device 102 (e.g., a display, a speaker, one or more light-emitting diodes (LEDs), and/or the like). The asset transaction system 114 can include a software application, such as a cloud-based software application providing a variety of data processing functionalities including, for example, authentication services, asset selection, asset management, asset conversion, asset transaction, and/or the like.

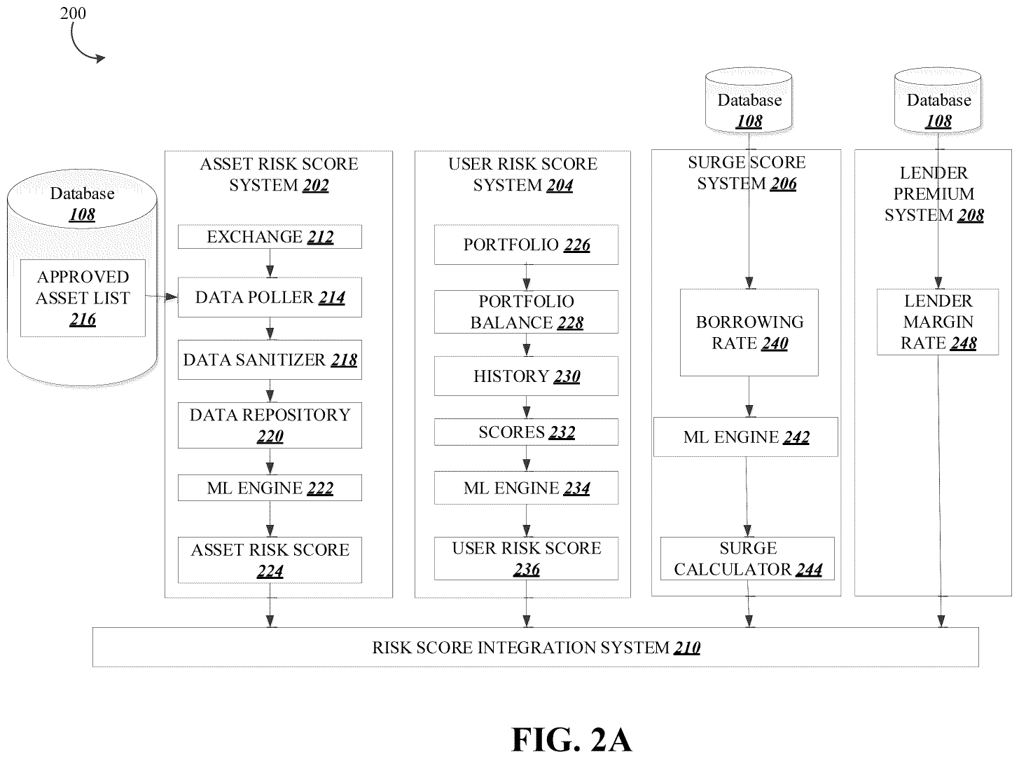

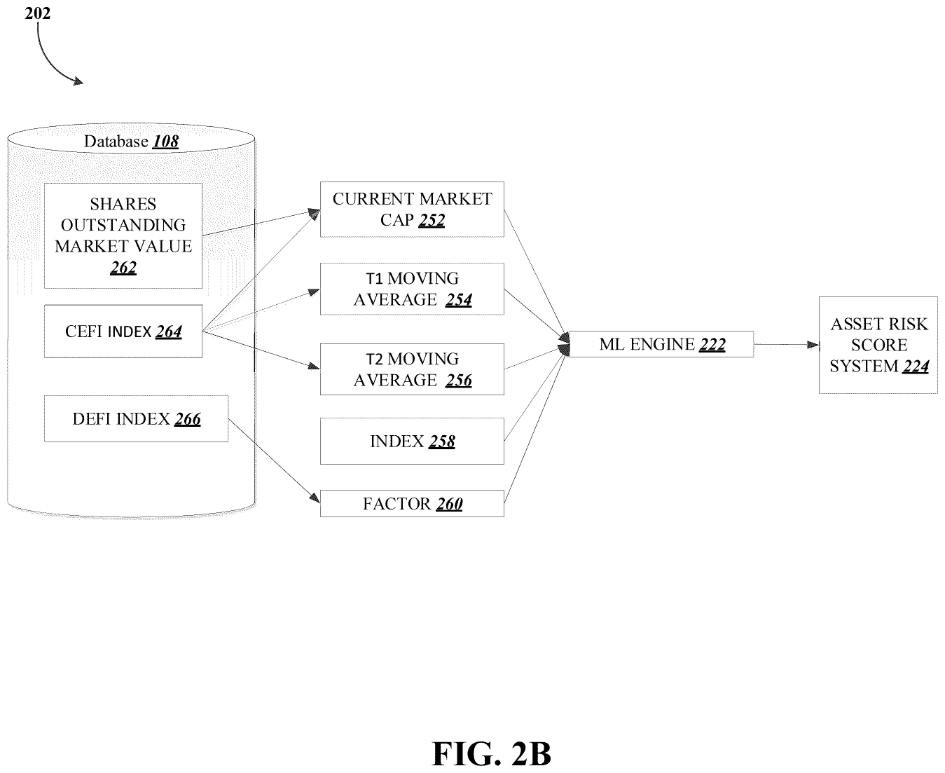

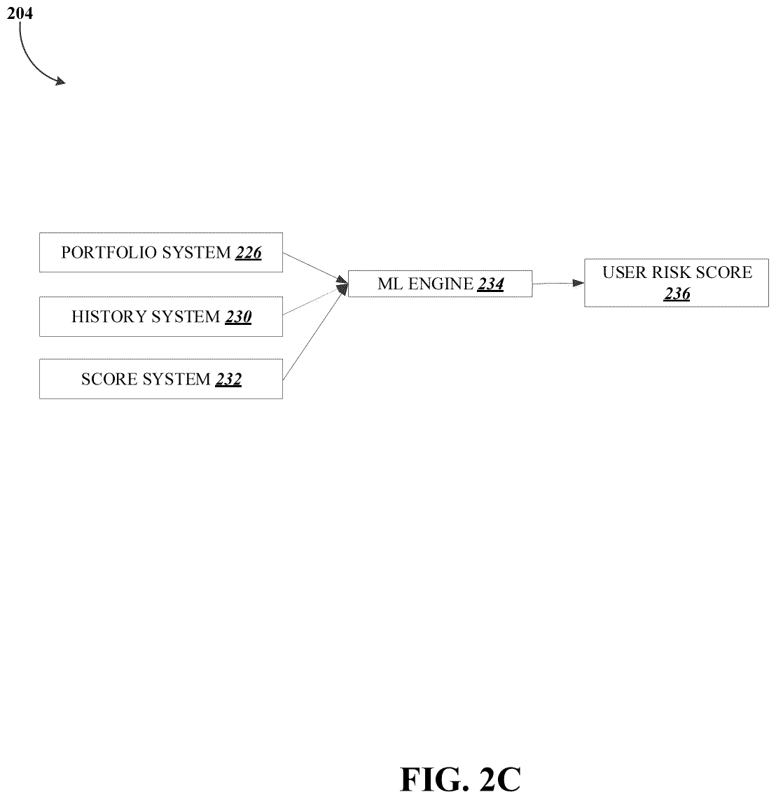

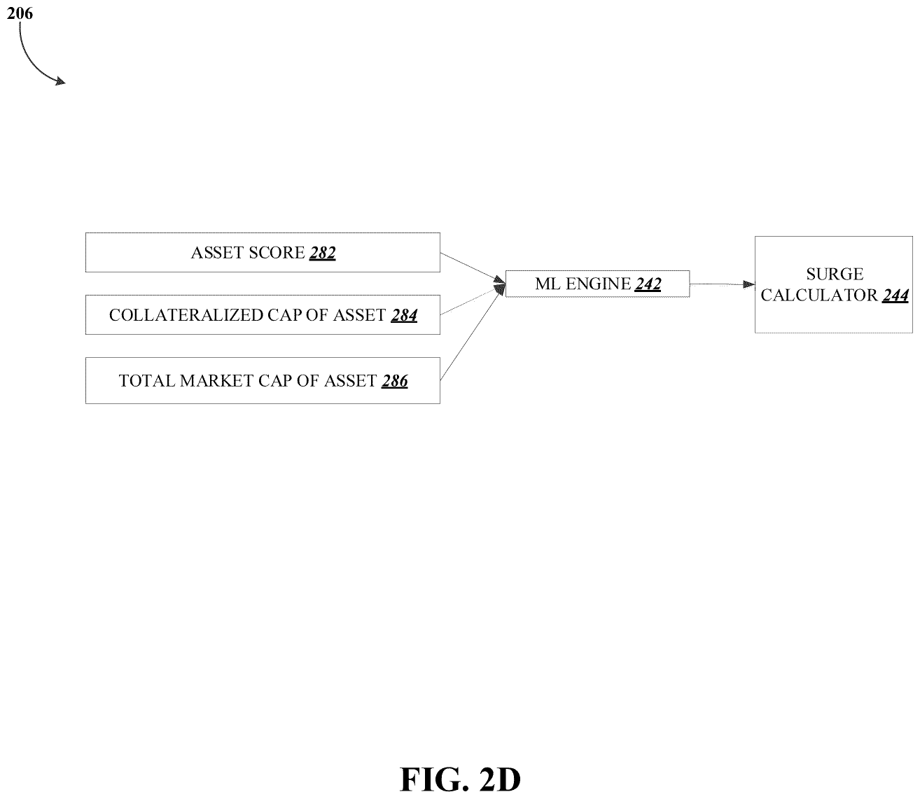

The data analysis system 104 can include any form of servers including, but not limited to a web server (e.g., cloud-based server), an application server, a proxy server, a network server, and/or a server pool. The data analysis system 104 can include a risk score system 116 and a database 118. The risk score system 116 can include a secure gateway to receive historical data from the database 118. The risk score system 116 can provide asset management, asset conversion, and/or asset transaction services for any type of tangible and non-tangible assets. The risk score system 116 can implement at least one ML model (e.g., at least one multilayer perceptron (MLP), at least one convolutional neural network (CNN), at least one recurrent neural network (RNN), at least one data encoder, at least one asset converter, and/or the like). For example, the models can utilize Long Short-Term Memory (LSTM) and Recurrent Neural Network (RNN) to process incoming data and to generate outputs, having high accuracy in processing and predicting time series data over a period of time. In some examples, risk score system 116 can implement at least one ML model as part of an asset conversion process (e.g., a pipeline for identifying one or more objects located in an environment and/or the like). An example of an implementation of a ML model is included below with respect to FIGS. 2A-2D. The data analysis system 104 can be configured to process asset data retrieved from the database 118 to execute asset conversion and transaction operations. The database 118 can store historical data 120 associated with assets of a user of the user device 102 and asset data 122 (including approved asset lists). The database 118 can be include a multitenant database architecture (e.g., multitenant database containers (MDC)), such that each tenant of the data analysis system 104 (using a respective user device 102) can customize respective asset data stored by the database 118 and can be served by separate instances of the data analysis system 104 when using cloud-based software applications accessible through the asset transaction system 114.

The asset custodian system 106 can include any form of servers including, but not limited to a web server (e.g., cloud-based server), an application server, a proxy server, a network server, and/or a server pool. The asset custodian system 106 can include an asset custody system 124 and a database 126. The asset custody system 124 can provide asset management and/or asset transaction services for non-tangible assets under custody. In some examples, the asset custody system 124 can manage and process asset data 128 stored by the database 126 to enable asset conversion and transaction operations. The database 126 can store asset data 128 associated with non-tangible assets of a user of the user device 102. The database 126 can be include a multitenant database architecture (e.g., multitenant database containers (MDC)), such that each tenant of the asset custodian system 106 (using a respective user device 102) can customize respective asset data stored by the database 126 and can be served by separate instances of the asset custodian system 106 when using cloud-based software applications accessible through the asset transaction system 114.

The database 108 can include a cloud database system environment, although other types of databases can be used as well. In some implementations, the database 108 can include a publicly accessible database. The database 108 can include a runtime database that holds most recent external data. The database 108 can store any type of external data that can be updated in real time and can be used by the data analysis system 104 for asset conversion and asset transactions. For example, the database 108 can store external data, including market data 130 and interest rates 132, that can be accessible (e.g., via queries, procedure calls, etc.) by the data analysis system 104, by the user device 102, and by the asset custodian system 106.

The network 110 can be any wired and/or wireless network including, for example, a public land mobile network (PLMN), a local area network (LAN), a wide area network (WAN), the Internet, a cellular network, a telephone network (e.g., PSTN) or an appropriate combination thereof connecting any number of communication devices, mobile computing devices, fixed computing devices, server systems, and/or the like.

With continued reference to FIG. 1, one or more functions are described as being performed by the example system 100. The number and arrangement of the components and/or devices of the example system 100, shown in FIG. 1 are provided as an example. There may be additional systems and/or devices, fewer systems and/or devices, different systems and/or device, or differently arrangement systems and/or devices than those shown in FIG. 1. Furthermore, two or more systems and/or devices show in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices) of the example system 100 may perform one or more functions described as being performed by another set of systems or another set of devices of the example system 100.

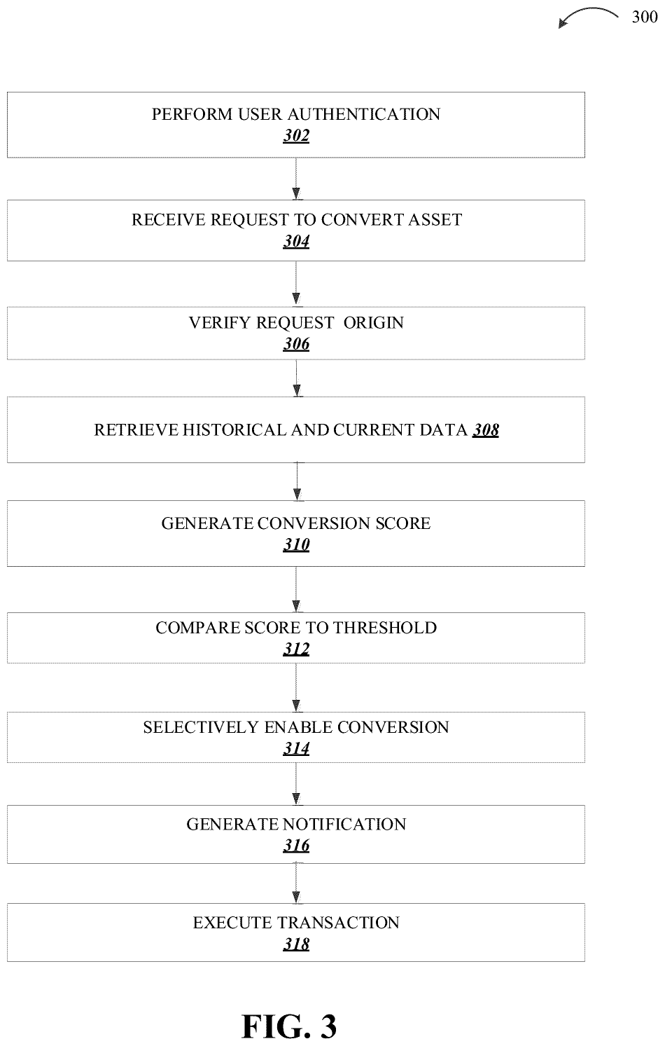

The user interface 112 can enable an entry of a user input including user authentication information, data associated to target assets (e.g., non-tangible assets handled by the asset custodian system 106), such as asset identification (e.g., name and type of assets), and target asset modification (conversion) for use in association with asset transaction applications provided (e.g., as a service) by the data analysis system 104. In general, the data analysis system 104 uses the risk score system 116 to manage asset conversions and transactions of assets that can be under custody of the asset custodian system 106. The data analysis system 104 can be configured to provide access, during authenticated sessions, to cloud-based software applications of the risk score system 116 for asset customization services, to any number of user devices (e.g., the user device 102) over the network 110. In some example implementations, the risk score system 116 can operate on data stored in one or more databases 108, 118, 126. For example, the risk score system 116 can store, retrieve, update, and/or delete data from the database 118 and can retrieve data from databases 108, 126 to generate an accurate conversion score for asset conversion. In some implementations, the risk score system 116 can transmit data to the database 126 to modify asset data 128 based on asset transactions. The asset conversion and transaction process is further described in detail with reference to FIGS. 2 and 3.

In some implementations, the example system 100 can include a blockchain network. For example, one or more components of the example system 100 (e.g., the user device 102, the data analysis system 104, the asset custodian system 106, and the external database 108) can be included in or connected to a blockchain node. A transaction described in one or more embodiments in this disclosure can refers to asset conversion data created by a node of a blockchain and can be published to blocks of the blockchain. The transactions in the blockchain can be classified into transactions in a narrow sense and transactions in a broad sense. A transaction in a narrow sense refers to an asset transfer published by the user device 102 or the data analysis system 104 to the blockchain. For example, in a traditional Bitcoin blockchain network, a transaction can be a transfer initiated by the user device 102 in the example system 100 configured as a blockchain. A transaction in a broad sense can refers to asset data published by the user device 102 to the blockchain through a node, after the data analysis system 104 converted the asset originally under the custody of the asset custodian system 106, such as the ledger transaction for storing ledger content and the unique identification code of the target tangible asset. Multiple nodes on the blockchain (such as nodes of multiple asset custodian system 106) can store asset information for a target asset on the blockchain, in order to unify the coding logic of the asset identification code of each node to prevent the same target asset from having multiple identification codes, the unique identification codes of the target asset described in the one or more embodiments can be generated by a smart contract running on the blockchain.

With continued reference to the example system 100 including a blockchain network, asset conversion and transaction applications can include, but are not limited to, smart contracts. A smart contract can be described as a digital representation of a real-world legal contract that has contract terms that affect the parties. The smart contract can be implemented, stored, updated (as needed), and executed within the blockchain network. Contract parties (for example, buyers and sellers of the tangible asset) associated with a smart contract are represented as nodes in the blockchain network. In some examples, the smart contract can include data that can be used to store information, facts, associations, balances, and any other information needed to implement contract execution logic. The smart contract can be described as a computer-executable program consisting of functions, in which an instance of the smart contract can be created and a function invoked to execute the logic specified by the smart contract. The smart contract can be implemented based on objects and object-oriented classes. For example, the terms and components of a smart contract can be represented as object handled by an application that implements the smart contract. A smart contract (or an object in a smart contract) can invoke another smart contract (or an object in the same smart contract) like other object-oriented objects. For example, an invoking made by an object can be invoking creating, updating, deleting, propagating, or communicating with an object of another class. Invoking between objects can be implemented by functions, methods, application programming interfaces (APIs), or other invoking mechanisms. For example, a first object can invoke a function to create a second object. It can be known from the above that, in yet another embodiment shown, the unique identification code of the target asset is obtained by a node of the blockchain invoking a smart contract deployed on the blockchain. The smart contract can declare a logic that generates the unique identification code for the target tangible asset based on attribute information of the non-tangible target asset under custody of the asset custodian system 106. The attribute information of the target asset includes information, such as an address of the target asset, ownership of the asset right, or a serial number of the real estate certificate, and is used to uniquely identify the target asset can be stored as asset data 122 by the database 118 associated with a blockchain node.

The smart contract can include logical rules stored by a distributed database, such as database 108, 118, to define consensus verification of the nodes of the example system 100 configured as a blockchain. The unique identification code for the target asset generated by invoking the smart contract can ensure the uniformity of the rules for obtaining the unique identification code of the target asset, and the one-to-one correspondence between the unique identification code and the target asset. The value of the target asset can be determined based on analytical parameters retrieved from the ledger content and current conversion data. The ledger content can include a variety of specific information contents according to specific asset conversion and transaction scenarios or requirements for ledger. For example, the ledger content can include the attribute information of the target asset. In some embodiments, the ledger content includes respective hash values of asset transactions stored in an encrypted way in the distributed database 108 provided by the example system 100 configured as a blockchain, and other ledger transaction can include the unique identification code of the target asset and another ledger content. By collecting the hash value of other ledger transaction stored on the blockchain into the ledger content of the ledger transaction described above, the ledger transaction can be associated with the other ledger transaction. The other ledger transaction can also include a hash value of other ledger transaction about the target asset. The ledger information data link of the target asset can be established to facilitate each node to effectively and securely search historical data including analytical parameters (e.g., various ledger contents regarding the target asset).

FIG. 2A depicts a block diagram illustrating an example of a risk score architecture 200, in accordance with some example implementations. The example risk score architecture 200 can be integrated in one or more components of the example system 100, such as data analysis system 104 described with reference to FIG. 1. The risk score architecture 200 can include an asset risk score system 202, a user risk score system 204, a surge score system 206, a lender premium system 208, and a risk score integration system 210.

The risk score system 202 can include exchange connections 212 to retrieve data from multiple sources. For example, the exchange connections 212 can include centralized finance (CeFi) exchange connections and decentralized finance (DeFi) exchange connections. The CeFi exchange connections can include connections with major centralized asset exchange platforms, such as auction markets, dealer markets and other asset related markets. The CeFi exchange connections can include one or more Application Programming Interfaces (APIs) configured to extract asset data from centralized asset market terminals to receive market data. The DeFi exchange connections can include connections with major decentralized asset exchange platforms. The DeFi exchange connections can receive tokenized asset data. The exchange connections 212 can be configured to send the retrieved asset data to the data poller 214.

The poller 214 can be configured to retrieve an approved asset list from a database 118. The poller 214 can process the collected data to track market data from the CeFi and DeFi exchanges relative to indices of the assets included in the approved asset list 216. The poller 214 can transmit the tracked market data to a data sanitizer 218.

The data sanitizer 218 can extract from the tracked data one or more asset attributes relevant for the asset risk score calculation. For example, the data sanitizer 218 can parse data collected by the poller 214 and processes it by validating, formatting, structuring and enriching the data. The data sanitizer 218 can also autocorrect asset attributes in cases where the data is incorrect and/or incomplete. The data sanitizer 218 can transmit the asset attributes to a data repository 220 accessible by ML engine 222.

The ML engine 222 can include a convolutional neural network (CNN). The CNN includes a plurality of convolution layers including first convolution layer, second convolution layer, and convolution layer. In some embodiments, CNN includes a sub-sampling layer (sometimes referred to as a pooling layer). In some embodiments, the sub-sampling layer and/or other subsampling layers have a dimension (i.e., an amount of nodes) that is less than a dimension of an upstream system. By virtue of sub-sampling layer having a dimension that is less than a dimension of an upstream layer, CNN consolidates the amount of data associated with the initial input and/or the output of an upstream layer to thereby decrease the amount of computations necessary for CNN to perform downstream convolution operations. Additionally, or alternatively, by virtue of sub-sampling layer being associated with (e.g., configured to perform) at least one subsampling function, CNN consolidates the amount of asset data associated with the initial input. In some embodiments, CNN generates an output based on asset data stored in the data repository 220 performing convolution operations associated with each convolution layer. In some examples, CNN generates an output based on asset data performing convolution operations associated with each convolution layer and an initial input. In some embodiments, the output of the convolution layer includes asset data associated with a plurality of output feature values that represent a prediction of an asset risk.

In some embodiments, the asset risk score system 224 identifies a prediction from among multiple predictions identifying an asset risk score as a value that is associated with the highest likelihood of being the correct prediction from among the plurality of predictions. For example, where fully connected layer includes asset values F1, F2, . . . . FN, and F1 is the greatest feature value, the asset risk score system 224 identifies the prediction associated with F1 as being the correct prediction from among multiple predictions. The asset risk score system 224 transmits the asset risk score to the risk score integration system 210.

The user risk score system 204 can include a portfolio system 226. The portfolio system 226 can store in a structured (aggregated form) asset data associated with a user (e.g., asset borrower). The portfolio system 226 can include a set of assets (DeFi and CeFi) owned by the user. The portfolio system 226 can be accessible by a portfolio balance system 228. The portfolio balance system 228 can be configured to process the asset data stored by the portfolio system 226 to determine an overall asset value (e.g., quantitative numerical value corresponding to a set currency) of the owned assets as calculated based on traditional market trades. The portfolio balance system 228 can send the overall asset value to the history system 230. The history system 230 can be configured to store historical asset data for past trading transactions of the user relative to the overall asset values determined at different time points of the user transaction history. The asset risk score system can process the historical asset data to determine a user credit score (e.g., Fair Isaac Corporation (FICO) score and a user DeFi credit score). The FICO score can include a value of creditworthiness assigned to the user in the CeFi space. The user DeFi credit score can include a value of creditworthiness assigned to the user in the DeFi space. The ML engine 234 can include a CNN, similar to the ML engine 222. The ML engine 234 can be configured to process the user credit scores to generate multiple predictions identifying a user risk score 236.

The surge score system 206 can include a borrowing rate predictor system 240 model that determines the cost of borrowing based on several external factors, such as ongoing and projected interest rates and other economic factors that can be retrieved from the database 108. The borrowing rate predictor system 240 can send the estimated cost of borrowing and the external factors to the ML engine 242, which can predict a risk of borrowing heavily leveraged assets. The ML engine 242 can include a CNN, similar to the ML engine 222. The ML engine 242 can send the predicted risk of borrowing heavily leveraged assets to the surge calculator 244.

The surge calculator 244 can process the predicted risk to determine a surge score used to adjust the DeFi score relative to a borrowing popularity of the asset across multiple users at a platform level, at a particular time (e.g., within a time period). The surge calculator 244 can determine a surge score including an increase in rates to adjust the DeFi Score, in order to reduce the risk of overexposure to a single security when multiple users borrow against the same security. For example, if 20 users borrow against company A within a period of 1 month, the surge calculator 244 can discourage the 21^{st} user from borrowing against company A. The surge score determined by the surge calculator 244 can also include a volatility of a particular security or entity within a time period (e.g., on a particular day, or over a number of days). For example, if company A reports a sudden bankruptcy, the surge calculator 244 can discourage borrowing against the bankrupted company's security by adjusting the surge score and the DeFi score.

The lender premium system 208 can be configured to provide a flat premium/discount decided by the lender in addition to the system calculated borrowing rate include a lender margin rate system 248. The lender margin rate system 248 can determine a lender premium associated with an asset based on several external factors, such as ongoing and projected interest rates and other economic factors that can be retrieved from the database 108. For example, during tight monetary policy, a lender entity may add an additional premium (e.g., premium basis points) to the borrowing rate, while during quantitative easing times, the lender entity may offer a discount (e.g., discount basis points).

The risk score integration system 210 can process the asset risk score received from the asset risk score system 202, the user risk score received from the user risk score system 204, the surge score received from the surge score system 206 and the lender premium received from the lender premium system 208 to generate a conversion score indicative of a value of the converted asset. Further details regarding the process performed by the risk score architecture 200 are described with reference to FIG. 3.

FIG. 2B illustrates an example of a security scoring model 202. The example security scoring model 202 can be used to determine the risk associated with a particular tangible (tradable) asset (e.g., security), when used as a collateral. The example security scoring model 202 includes a current market cap system 252, time moving average systems 254, 256, an index system 258, a factor system 260, the ML engine 222 and the asset risk system 224. The current market cap system 252 can retrieve from the database 108 data associated with shares relative to the market volume 262 and the CeFi index 264 (e.g., CeFi score values including open, close, high and low CeFi score values). The current market cap system 252 can process the data retrieved from the database 108 to track daily changes and determine market indices (e.g., predicted market volatility). The time moving average systems 254, 256 can retrieve from the database 108 data associated with the CeFi index 264 (e.g., CeFi score values including open, close, high and low CeFi score values) for respective time periods (e.g., 50 or 200 days). The index system 258 can generate parameters corresponding to open, close, low, and high asset prices. The factor system 260 can retrieve from the database 108 data associated with the DeFi index 266 (e.g., DeFi score values including open, close, high and low CeFi score values). The data collected and processed by the current market cap system 252, the time moving average systems 254, 256, the index system 258, and the factor system 260 can be normalized using set weights and sent to ML engine 222. The ML engine 222 can process the received data to classify and score the data to generate an asset risk score. The asset risk score includes a prediction of an asset (security) score based on associated asset (security) historical prices, market indices, and indicators data. The ML engine 222 can include a normalization function (e.g., Scikit-learn model or MinMaxScaler model) that is used to normalize the asset risk score to have a value between 0 and 1. The higher the quality of the asset, the greater the score in the scale. The ML engine 222 can be periodically adjusted and re-trained using a gradient descent. The asset risk score generated by ML engine 222 can be used, by the asset risk score system 224 to classify and process the data to predict a risk profile for each asset.

FIG. 2C illustrates an example of a user risk score model 204. The example user risk score model 204 can be used to determine the risk associated with a particular user for a transaction of a tangible (tradable) asset (e.g., security), when used as a collateral. The example user risk score model 204 includes the portfolio system 226, the history system 230, the (asset risk) score system, the ML engine 234, and the user risk score system 236. The portfolio system 226 can process structured (aggregated form) asset data associated with a user (e.g., asset borrower). The portfolio system 226 can indicate a quality of the overall portfolio of assets held in the user's account, each quantified with respective scores obtained from the asset risk score system 224. The portfolio system 226 can send the overall asset value to the ML engine 234. The history system 230 can be configured to process historical asset data (borrowing and repayment history) for past trading transactions of the user relative to the overall asset values determined at different time points of the user transaction history. The historical asset data can include a loan profile, including existing assets, liabilities, loan to debt ratio, and income history, and a payment profile, including existing loans in the platform, repayment history, and delinquent frequency. The history system 230 can determine historical trends from the processed historical asset data and transmit the historical trends to the ML engine 234. The asset risk score system 232 can retrieve a user CeFi credit score (e.g., FICO, Experian, TransUnion, etc.) and the user DeFi credit score from one or more sources. The data collected and processed by the portfolio system 226, the history system 230, and the asset risk score system 232 can be normalized using set weights and sent to ML engine 234. The ML engine 234 can process the received data to classify and score the data to generate predictions identifying the user risk score. The user risk score includes a prediction of risk of a user to borrow against an asset (security) based on the input data. The ML engine 234 can include a normalization function (e.g., Scikit-learn model or MinMaxScaler model) that is used to normalize the user risk score to have a value between 0 and 1. The lower the risk, the greater the score is in the scale. The ML engine 234 can be periodically adjusted and re-trained using a gradient descent. The user risk score generated by ML engine 234 can be used, by the user risk score system 236 to classify and process the data to predict a risk profile for the user relative to each asset.

FIG. 2D illustrates an example of a surge score model 206. The example surge score model 206 can be used to determine the risk for the lender to accept a particular asset (security) as a collateral during a particular timeframe (typically between 1-7 days). The example surge core model 206 includes an asset score system 282, a collateralized cap of asset system 284, a total market cap of asset system 286, the ML engine 242, and the surge calculator 244. The asset score system 282 can determine a score of the underlying asset (security). The collateralized cap of asset system 284 can determine the total collateralized market cap of the selected asset (security) at a set time. The total market cap of asset system 286 can determine the current total market cap of the selected asset (security). The asset score system 282, the collateralized cap of asset system 284, and the total market cap of asset system 286 can transmit the generated data to the ML engine 242. The ML engine 242 can continuously monitor the received data using a selected model (e.g., recurrent neural network) to determine a surge score indicating whether collateralization of the selected asset (security) is trending higher or lower than usual. The trends can be determined by comparing the surge score to predetermined upper and lower bounds, or can be determined based on ongoing time-series data analysis using other statistical methods, such as Bollinger's Bands, etc. The increase in surge score inversely impacts the overall DeFi score, so that further collateralization of over-subscribed securities is discouraged, and ultimately stopped (circuit-breaker) after a certain threshold. The surge score can also change based on any sudden drop in market value of a particular asset beyond a certain threshold, thereby acting as a circuit-breaker in such scenarios. If the collateralized assets fall below the threshold levels, further collateralization can be automatically permitted. The surge calculator 244 can provide the final risk score to predict an accurate surge model for the transaction.

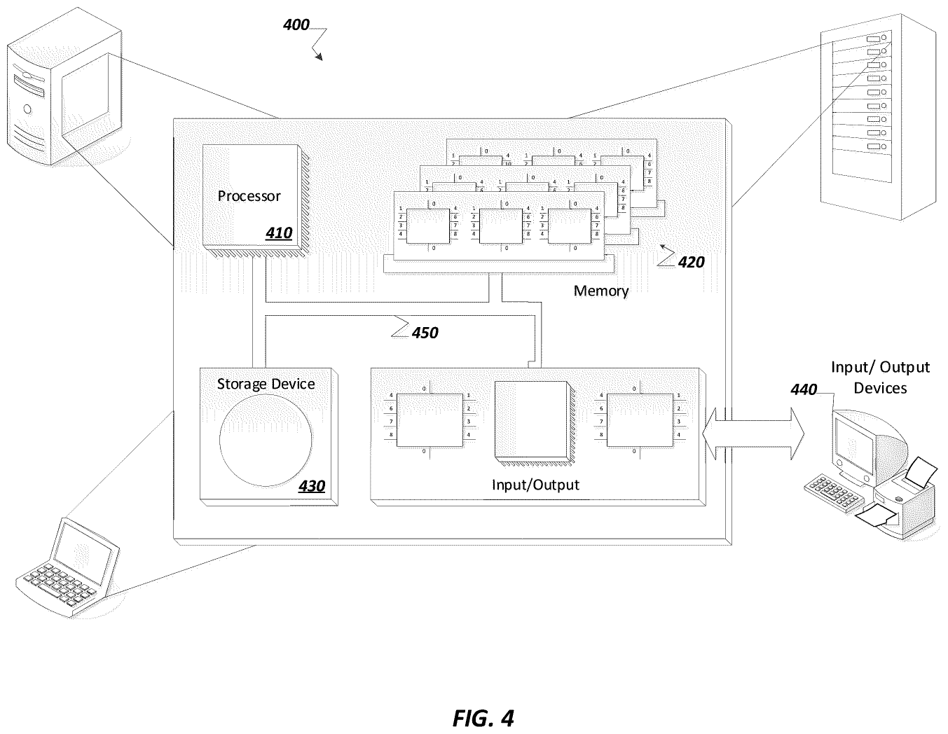

FIG. 3 depicts a flowchart illustrating a process 300 for managing asset transactions in accordance with some example implementations. The process 300 can be executed by the system 100 shown in FIG. 1, using the score models shown in FIGS. 2A-2D, the system 400 shown in FIG. 4 or any combination thereof.

At 302, a user authentication is performed. In some implementations the user authentication is performed by a user device (e.g., user device 102 described with reference to FIG. 1) or by a data analysis system (e.g., data analysis system 104 described with reference to FIG. 1), at the request of the user device. The user authentication can include a verification of a user identity (e.g., registered user of the data analysis system) and a user password. The verification of a user identity and/or a user password can include processing of a user identifier (e.g., name, account number, email address, etc.) and/or a biometric information (e.g., image, finger print, voice print, etc.) captured by a sensor (e.g., camera, microphone, keypad entry) of the user device.

At 304, in response to successful user authentication, a request to convert a non-tangible (intangible) asset (e.g., off-balanced asset of a variable value, such as a non-monetary asset that cannot be seen or touched) to a tangible asset (e.g., an asset that can be seen or touched having a set monetary value) form for a transaction is received by the data analysis system. The asset can include a blockchain asset. The non-tangible asset can be selected from a displayed asset section. In some implementations, one or more asset sections can be displayed by the user interface of the user device. The asset sections can include traditional assets (e.g., equity funds, mutual funds, etc.), crypto assets (e.g., cryptocurrencies) or other asset types. The assets can be displayed, by the user interface of the user device, on a dashboard with an option to select one or more assets. The user input can select one or more assets at the same time. On selection, the rows can be highlighted. The request can be received, from a user device (e.g., user device 102 described with reference to FIG. 1) by a data analysis system (e.g., data analysis system 104 described with reference to FIG. 1).

At 306, an asset selection origin is verified, by the data analysis system. For example, a user account can be restricted to select only assets that are linked to the user's profile. The data analysis system can verify that the user account is authorized to initiate asset conversion and/or transaction for the selected asset. In some implementations, verification of the asset selection origin can include determining whether the selection originates from a whitelisted server associated with user accounts authorized to initiate asset conversion and/or transaction for the selected asset.

At 308, historical and current data are retrieved, by the data analysis system, from a database. The historical data can include analytical parameters associated with the one or more assets and asset holder. The analytical parameters can include asset related data recorded over a past period of time, such as a loan profile, including transactions associated with existing assets, liabilities, loan to debt ratio, and income history, and a payment profile, including existing loans in the platform, repayment history, and delinquent frequency. The analytical parameters can be stored as hash values of asset transactions stored in an encrypted way in a distributed database (e.g., the distributed database 108, described with reference to FIG. 1) of a system (e.g., the example system 100, described with reference to FIG. 1) configured as a blockchain.

The entire historical dataset can be categorized in four segments-customer data, platform data, market data, and custodian data. The historical data is categorized across the various categories, and the data points such as asset score, repayment score, portfolio score, are used to classify the user's risk score. For newer system users, who do not have an associated platform data or limited historical data, the system relies on the portfolio data. The current data can include current conversion factors applicable to the one or more selected assets associated with the user, such as external (market) values associated with the asset. The external values associated with the asset can include market indices (e.g., market volatility predicted based on current values) that can affect the overall value of the asset, as described with reference to FIGS. 2A-2D.

At 310, a conversion score is generated, by the data analysis system, by processing the historical data and the current data. The conversion score can be indicative of a value of the target asset type and could be used as a multiplication factor to derive the target asset value from the original asset value. The conversion score includes an integration of multiple risk scores including the asset risk score, the user risk score, the surge risk score, the lender premium, as described with reference to FIGS. 2A-2D. For example, the conversion score can include a weighted sum of the multiple risk scores. Each of the multiple risk scores can be determined using a respective ML engine configured to perform a convolution function. For example, the convolution function can process the historical data and the current data by performs the first convolution function based on CNN providing the values representing the historical data and the current data as input to one or more neurons included in a convolution layer. In this example, the values representing the historical data and the current data can correspond to values representing a region of the asset, user, market, and/or lender trends (sometimes referred to as a receptive field). In some embodiments, each neuron is associated with a filter. A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex trend patterns (e.g., arcs, objects, and/or the like). In some embodiments, CNN performs the convolution function based on CNN multiplying the values provided as input to each of the one or more neurons included in first convolution layer with the values of the filter that corresponds to each of the one or more neurons. For example, CNN can multiply the values provided as input to each of the one or more neurons included in first convolution layer with the values of the filter that corresponds to each of the one or more neurons to generate a single value or an array of risk prediction values as an output. In some embodiments, the collective output of the neurons of first convolution layer is referred to as a convolved output. In some embodiments, where each neuron has the same filter, the convolved output is referred to as a feature map. In some embodiments, CNN provides the outputs of each neuron of first convolutional layer to neurons of a downstream layer. For purposes of clarity, an upstream layer can be a layer that transmits data to a different layer (referred to as a downstream layer). For example, CNN can provide the outputs of each neuron of first convolutional layer to corresponding neurons of a subsampling layer. In an example, CNN provides the outputs of each neuron of first convolutional layer to corresponding neurons of first subsampling layer. In some embodiments, CNN adds a bias value to the aggregates of all the values provided to each neuron of the downstream layer. For example, CNN adds a bias value to the aggregates of all the values provided to each neuron of first subsampling layer. In such an example, CNN determines a final value to provide to each neuron of first subsampling layer based on the aggregates of all the values provided to each neuron and an activation function associated with each neuron of first subsampling layer. In some implementations, the ML engine include a CNN configured to generate as output a subsampled convolved output. In some implementations, the conversion score can be normalized to be in a range from 0 to 1. As the system obtains more data around market events and user's repayment history of converted assets, the weights associated to each factor is reviewed periodically and adjusted to improve the accuracy of the conversion score. The accuracy of conversion score is improved by including more training data related to assets with different regression and risk scores.

At 312, the conversion score is compared, by the data analysis system, to a threshold. The conversion score threshold can be a static threshold or a dynamic threshold. The static threshold can include a set value. The dynamic threshold enables a comparison of the conversion score with a threshold trend or range. The conversion score can be transmitted to user devices to be displayed on graphical user interfaces as graphs (including score trends illustrating multiple score values as described with reference to FIGS. 2A-2D) and/or with highlights or color codes (green for scores exceeding the conversion threshold and red for scores below the conversion threshold) of the conversion score relative to the threshold.

At 314, the comparison results can be used, by the data analysis system, to selectively enable the asset conversion. For example, for conversion cores exceeding the conversion threshold, a connection with an asset custodian system (e.g., asset custodian system 106 described with reference to FIG. 1) can be initiated to effectively convert the asset selected and approved for conversion.

At 316, a notification is generated, by the data analysis system, to be displayed by the user devices. The notification can include the conversion score, an estimated target asset value, and a transaction execution option that can enable a user to authorize execution of the transaction. For example, a first user device of the user (e.g., borrower) and a second user device (e.g., asset custodian system) can display the notification.

At 318, the transaction is executed, by the data analysis system. The transaction execution can include initiation of connections with various third party providers (e.g., nodes of a blockchain) to link the converted assets by using APIs that connect to the third party platforms and transfer information of the assets held with them. In some implementations, where the data analysis system is included in a blockchain, a smart contract can be used to execute the transaction. For example, smart contracts can be implemented based on objects and object-oriented classes. For example, the terms and components of a smart contract can be represented as object handled by an application that implements the smart contract. A smart contract (or an object in a smart contract) can invoke another smart contract (or an object in the same smart contract) like other object-oriented objects. For example, an invoking made by an object can be invoking creating, updating, deleting, propagating, or communicating with an object of another class. Invoking between objects can be implemented by functions, methods, application programming interfaces (APIs), or other invoking mechanisms. For example, a first object can invoke a function to create a second object. A unique identification code of the target asset can be obtained by a node of the blockchain invoking a smart contract deployed on the blockchain. The smart contract declares a logic that generates the unique identification code for the target asset based on attribute information of the target asset. The attribute information of the target asset includes information such as an address of the target asset, ownership of the property right, or a serial number of the real estate certificate, and is used to uniquely identify the target asset. The logical rules declared by the smart contract can be included in a distributed database provided by the blockchain after being subject to the consensus verification of the nodes of the blockchain. The transaction execution can include obtaining the unique identification code for the target asset by invoking the smart contract can ensure the uniformity of the rules for obtaining the unique identification code of the target asset, and the one-to-one correspondence between the unique identification code and the target asset.

The example process 300 enables a computationally efficient integration of cryptocurrency with traditional security instruments to provide instant conversion of nontangible assets into tangible assets. The example process 300 maintains data security and asset security by restricting the conversion process to authorized users. The example process 300 can be executed by a blockchain system that has the characteristics of ensuring data security and anti-tampering. Using the example process 300, different components of the example system (e.g., the user device, the data analysis system, and the asset custodian system) can collaborate to minimize the risk for all the parties associated with the asset conversion and transaction. The direct access to the external database (e.g., database 108 described with reference to FIGS. 1 and 2A-2D), enables elimination of new database table replication, minimizing storage resources, and optimizing computational resources involved in determining the risk scores used to selectively enable the transaction using the example process 300, which includes operations that are not routine conventional and well known activities.

In some implementations, the current subject matter can be configured to be implemented in a system 400, as shown in FIG. 4. The system 400 can include a processor 410, a memory 420, a storage device 430, and an input/output device 440. Each of the components 410, 420, 430 and 440 can be interconnected using a system bus 450. The processor 410 can be configured to process instructions for execution within the system 400. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

In some implementations, one or more application function libraries in the plurality of application function libraries can be stored in the one or more tables as binary large objects. Further, a structured query language can be used to query the storage location storing the application function library.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more user device computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include user devices and servers. A user device and server are generally, but not exclusively, remote from each other and typically interact through a communication network. The relationship of user device and server arises by virtue of computer programs running on the respective computers and having a user device-server relationship to each other.

Further non-limiting aspects or implementations are set forth in the following numbered examples:

Example 1: A system comprising: one or more computer processors; a database storing a plurality of documents, the plurality of documents comprising asset related documents; a data analysis system, executable upon the one or more computer processors, to perform operations comprising: receiving a request to convert one or more assets that are linked to a user, retrieving, from a database and by using a user identifier, historical data and current data associated with the one or more assets, the historical data comprising analytical parameters associated with the one or more assets and the current data comprising current conversion factors applicable to the one or more assets, generating a conversion score for converting the one or more assets, the conversion score comprising a weighted sum of a plurality of risk scores, each of the plurality of risk scores being determined by using a machine learning model comprising a convolution function configured to process the historical data and the current data, selectively enabling a conversion of the one or more assets based on a comparison of the conversion score to a conversion threshold, using the conversion to automatically generate an update of the current data associated with the one or more assets, and providing an instruction to display information indicating the conversion and the update of the current data associated with the one or more assets.

Example 2: The system of example 1, wherein the operations further comprise: performing a user authentication; determining whether the request originates from a whitelisted server; and retrieving, from a risk score system, via a secure gateway, the historical data associated with the user.

Example 3: The system of any one of the preceding examples, wherein the historical data is encrypted for transmission, via the secure gateway.

Example 4: The system of any one of the preceding examples, wherein the operations further comprise: generating a notification indicating completion of asset conversion.

Example 5: The system of any one of the preceding examples, wherein one of the one or more assets comprises a blockchain asset.

Example 6: The system of any one of the preceding examples, wherein selectively enabling the conversion of the one or more assets comprises blocking the conversion of the one or more assets based on determining that the conversion score is smaller than the conversion threshold or automatically executing the conversion of the one or more assets based on determining that the conversion score is greater than the conversion threshold.

Example 7: The system of example 6, wherein the conversion of the one or more assets comprises generating a converted asset value.

Example 8: The system of any one of the preceding examples, wherein the machine learning model comprises a recurrent neural network.

Example 9: The system of example 7, wherein the operations further comprise: executing, using a smart contract, a transaction of the one or more assets using the converted asset value.

Example 10: The system of any one of the preceding examples, wherein the analytical parameters comprise data recorded over a past period of time, encrypted, and stored in a distributed database of a system.

Example 11: The system of any one of the preceding examples, wherein the current conversion factors comprise external values associated with the asset.

Example 12: A non-transitory computer-readable storage medium comprising programming code, which when executed by at least one data processor, causes operations comprising: receiving a request to convert one or more assets that are linked to a user, retrieving, from a database and by using a user identifier, historical data and current data associated with the one or more assets, the historical data comprising analytical parameters associated with the one or more assets and the current data comprising current conversion factors applicable to the one or more assets, generating a conversion score for converting the one or more assets, the conversion score comprising a weighted sum of a plurality of risk scores, each of the plurality of risk scores being determined by using a machine learning model comprising a convolution function configured to process the historical data and the current data, selectively enabling a conversion of the one or more assets based on a comparison of the conversion score to a conversion threshold, using the conversion to automatically generate an update of the current data associated with the one or more assets, and providing an instruction to display information indicating the conversion and the update of the current data associated with the one or more assets.

Example 13: The non-transitory computer-readable storage medium of example 12, wherein the historical data is encrypted for transmission, via a secure gateway.

Example 14: The non-transitory computer-readable storage medium of any one of the preceding examples, wherein one of the one or more assets comprises a blockchain asset.

Example 15: The non-transitory computer-readable storage medium of any one of the preceding examples, wherein selectively enabling the conversion of the one or more assets comprises blocking the conversion of the one or more assets based on determining that the conversion score is smaller than the conversion threshold or automatically executing the conversion of the one or more assets based on determining that the conversion score is greater than the conversion threshold.

Example 16: A computer-implemented method comprising: receiving, by one or more processors, a request to convert one or more assets that are linked to a user, retrieving, by the one or more processors, from a database and by using a user identifier, historical data and current data associated with the one or more assets, the historical data comprising analytical parameters associated with the one or more assets and the current data comprising current conversion factors applicable to the one or more assets, generating, by the one or more processors, a conversion score for converting the one or more assets, the conversion score comprising a weighted sum of a plurality of risk scores, each of the plurality of risk scores being determined by using a machine learning model comprising a convolution function configured to process the historical data and the current data, selectively enabling, by the one or more processors, a conversion of the one or more assets based on a comparison of the conversion score to a conversion threshold, using, by the one or more processors, the conversion to automatically generate an update of the current data associated with the one or more assets, and providing, by the one or more processors, an instruction to display information indicating the conversion and the update of the current data associated with the one or more assets.

Example 17: The computer-implemented method of example 16, further comprising: performing a user authentication; determining whether the request originates from a whitelisted server; and retrieving, from a risk score system, via a secure gateway, the historical data associated with the user.

Example 18: The computer-implemented method of any one of the preceding examples, wherein the historical data is encrypted for transmission, via the secure gateway.

Example 19: The computer-implemented method of any one of the preceding examples, wherein one of the one or more assets comprises a blockchain asset.

Example 20: The computer-implemented method of any one of the preceding examples, wherein selectively enabling the conversion of the one or more assets comprises blocking the conversion of the one or more assets based on determining that the conversion score is smaller than the conversion threshold or automatically executing the conversion of the one or more assets based on determining that the conversion score is greater than the conversion threshold.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. For example, the logic flows can include different and/or additional operations than shown without departing from the scope of the present disclosure. One or more operations of the logic flows can be repeated and/or omitted without departing from the scope of the present disclosure. Other implementations can be within the scope of the following claims.

What is claimed is:

1. A system comprising:
one or more computer processors;
a database storing a plurality of documents, the plurality of documents comprising asset related documents;
a data analysis system, executable upon the one or more computer processors, to perform operations comprising:
receiving a request to convert one or more assets that are linked to a user,
retrieving, from the database and by using a user identifier, historical data and current data associated with the one or more assets, the historical data comprising analytical parameters associated with the one or more assets and the current data comprising current conversion factors applicable to the one or more assets,
generating a conversion score for converting the one or more assets, the conversion score comprising a weighted sum of a plurality of risk scores, each of the plurality of risk scores being determined by using a machine learning model comprising a convolution function configured to process the historical data and the current data,
selectively enabling a conversion of the one or more assets based on a comparison of the conversion score to a conversion threshold,
using the conversion to automatically generate an update of the current data associated with the one or more assets, and
providing an instruction to display information indicating the conversion and the update of the current data associated with the one or more assets.

2. The system of claim 1, wherein the operations further comprise:
performing a user authentication;
determining whether the request originates from a whitelisted server; and
retrieving, from a risk score system, via a secure gateway, the historical data associated with the user.

3. The system of claim 2, wherein the historical data is encrypted for transmission, via the secure gateway.

4. The system of claim 1, wherein the operations further comprise:
generating a notification indicating completion of asset conversion.

5. The system of claim 1, wherein one of the one or more assets comprises a blockchain asset.

6. The system of claim 1, wherein selectively enabling the conversion of the one or more assets comprises blocking the conversion of the one or more assets based on determining that the conversion score is smaller than the conversion threshold or automatically executing the conversion of the one or more assets based on determining that the conversion score is greater than the conversion threshold.

7. The system of claim 6, wherein the conversion of the one or more assets comprises generating a converted asset value.

8. The system of claim 1, wherein the machine learning model comprises a recurrent neural network.

9. The system of claim 7, wherein the operations further comprise:
executing, using a smart contract, a transaction of the one or more assets using the converted asset value.

10. The system of claim 1, wherein the analytical parameters comprise data recorded over a past period of time, encrypted, and stored in a distributed database of a system.

11. The system of claim 1, wherein the current conversion factors comprise external values associated with the asset.

12. A non-transitory computer-readable storage medium comprising programming code, which when executed by at least one data processor, causes operations comprising:
receiving a request to convert one or more assets that are linked to a user,
retrieving, from a database and by using a user identifier, historical data and current data associated with the one or more assets, the historical data comprising analytical parameters associated with the one or more assets and the current data comprising current conversion factors applicable to the one or more assets,
generating a conversion score for converting the one or more assets, the conversion score comprising a weighted sum of a plurality of risk scores, each of the plurality of risk scores being determined by using a machine learning model comprising a convolution function configured to process the historical data and the current data,
selectively enabling a conversion of the one or more assets based on a comparison of the conversion score to a conversion threshold,
using the conversion to automatically generate an update of the current data associated with the one or more assets, and
providing an instruction to display information indicating the conversion and the update of the current data associated with the one or more assets.

13. The non-transitory computer-readable storage medium of claim 12, wherein the historical data is encrypted for transmission, via a secure gateway.

14. The non-transitory computer-readable storage medium of claim 12, wherein one of the one or more assets comprises a blockchain asset.

15. The non-transitory computer-readable storage medium of claim 12, wherein selectively enabling the conversion of the one or more assets comprises blocking the conversion of the one or more assets based on determining that the conversion score is smaller than the conversion threshold or automatically executing the conversion of the one or more assets based on determining that the conversion score is greater than the conversion threshold.

16. A computer-implemented method comprising:
receiving, by one or more processors, a request to convert one or more assets that are linked to a user,
retrieving, by the one or more processors and from a database and by using a user identifier, historical data and current data associated with the one or more assets, the historical data comprising analytical parameters associated with the one or more assets and the current data comprising current conversion factors applicable to the one or more assets,
generating, by the one or more processors, a conversion score for converting the one or more assets, the conversion score comprising a weighted sum of a plurality of risk scores, each of the plurality of risk scores being determined by using a machine learning model comprising a convolution function configured to process the historical data and the current data,
selectively enabling, by the one or more processors, a conversion of the one or more assets based on a comparison of the conversion score to a conversion threshold,
using, by the one or more processors, the conversion to automatically generate an update of the current data associated with the one or more assets, and
providing, by the one or more processors, an instruction to display information indicating the conversion and the update of the current data associated with the one or more assets.

17. The computer-implemented method of claim 16, further comprising:
performing a user authentication;
determining whether the request originates from a whitelisted server; and
retrieving, from a risk score system, via a secure gateway, the historical data associated with the user.

18. The computer-implemented method of claim 17, wherein the historical data is encrypted for transmission, via the secure gateway.

19. The computer-implemented method of claim 16, wherein one of the one or more assets comprises a blockchain asset.

20. The computer-implemented method of claim 16, wherein selectively enabling the conversion of the one or more assets comprises blocking the conversion of the one or more assets based on determining that the conversion score is smaller than the conversion threshold or automatically executing the conversion of the one or more assets based on determining that the conversion score is greater than the conversion threshold.
